(19) United States
(12) Patent Application Publication
(10) Pub. No.: US 2010/0192916 A1
(43) Pub. Date: Aug. 5, 2010

(54) RECIPROCATING PISTON SLEEVE VALVE ENGINE

(75) Inventor: James William Griffith Turner, Norfolk (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Lotus Cars Limited, Norwich (GB)

(21) Appl. No.: 12/094,141

(22) PCT Filed: Nov. 15, 2006
(86) PCT No.: PCT/GB2006/004256

§ 371 Date: Jun. 12, 2008

(30) Foreign Application Priority Data
Nov. 18, 2005 (GB) 0523553.6

(51) Int. Cl. F02B 75/04; F01L 5/06; F02B 31/00; F01L 9/04; F02M 69/04; F01L 7/02

(52) U.S. Cl. 123/48 C; 123/188.5; 123/306; 123/90.11; 123/445; 123/65 VA; 123/81 C

(57) ABSTRACT

A sleeve valve (13) slides axially along the cylinder (10) while simultaneously rotating about the axis of the cylinder (10). The sleeve valve (13) has sleeve ports (23). A piston (14) reciprocates within the sleeve valve (13) and within the cylinder (10) to define a combustion chamber. A sleeve valve driving mechanism (24, 25, 26, 27, 28, 29, 30, 31) drives the sleeve valve (13) to slide axially along and rotate in the cylinder (10) in timed relationship with reciprocation of the piston (14) in the cylinder (10). The sleeve valve (13) is driven between two extreme positions in each stroke and the sleeve driving mechanism (24, 25, 26, 27, 28, 29, 30, 31) is operable to vary in locations the two extreme positions.

The present invention relates to a reciprocating piston engine and in particular to such an engine which has a sleeve valve opening and closing the inlet and exhaust ports of the engine.

Sleeve valve engines are already known, for instance the “Burt-McCollum” sleeve valve engine. Sleeve valve engines were prevalent in the 1940s and 1950s in aircraft, due to the fact that they offer reduced mass, size and reduced total parts count together with increased power when compared with equivalent poppet valve engines. The Burt-McCollum sleeve valve engine gives an operation that reduces friction because the piston reciprocates within the sleeve, with the sleeve then moving in an elliptical motion within the cylinder and because the sleeve is never stationary with respect to a surrounding bore (to its outside) and with respect to the piston (on its inside), this continuous motion reduces friction by ensuring that there is always a good spread of lubricant between the sliding surfaces.

The parts count engine package size and complexity of sleeve engine are reduced in comparison with a poppet valve engine because gas exchange is performed via ports in the cylinder wall alternately covered and uncovered by a sleeve rather than cylinder head ports opened and closed by poppet valves. This in turn means that the cylinder head itself, where poppet valves are provided in a poppet valve engine, can in a sleeve valve engine instead be dedicated to other components now common in this part of the engine, e.g. direct fuel injectors (used both in compression ignition and spark ignition engines). The absence of poppet valves in the cylinder head also facilitates better cooling of the cylinder head, because cooling ducts can be located in areas through which the poppet valves and ports would extend in a poppet valve engine. This cooling is of particular benefit in the case of spark ignition engines because it allows the engine to operate safely at higher loads without suffering from pre-detonation (usually called “knock”).

Burt-McCollum Sleeve valves were manufactured for aircraft in larger numbers as four-stroke engines, e.g. the Napier Sabre engine and the Bristol Centaurus. They were manufactured in smaller numbers as two-stroke engines, e.g. the Ricardo E.65 engine and the Rolls-Royce Crecy engine.

In all of the sleeve valve engines of the prior art the driving mechanism for driving the sleeve valve drove the sleeve valve between two extreme positions fixed throughout operation of the engine (i.e. fixed in terms of the axial positions of the sleeve valve within the cylinder and also fixed in terms of the rotational positions of the sleeve valve within the cylinder).

According to the present invention there is provided a reciprocating piston internal combustion engine comprising:

a cylinder having a cylinder head and a side wall extending away from the cylinder head;

an inlet port defined in the cylinder side wall via which air is delivered to the cylinder;

an exhaust port defined in the cylinder side wall via which combusted gases are exhausted from the cylinder;

a sleeve valve which slides axially along the cylinder while simultaneously rotating about the axis of the cylinder, the sleeve valve having sleeve ports extending therethrough which move into and out of alignment with the inlet and exhaust ports to thereby open and close the ports;

a piston which reciprocates within the sleeve valve and within the cylinder to define therewith a combustion chamber; and

a sleeve valve driving mechanism which drives the sleeve valve to slide axially along and rotate in the cylinder in times relationship with reciprocation of the piston in the cylinder; wherein:

the sleeve valve is driven between two extreme positions in each stroke and the sleeve driving mechanism is operable to vary in locations the two extreme positions.

The present invention provides variable valve timing in a sleeve valve engine. Variable valve timing is now common in “state of the art” poppet valve engines, such engines having, for instance, one or more “cam phasers” which vary the timing of inlet valve opening/closing and/or exhaust valve opening/closing with changes in engine speed and load in order to optimise engine operation-to the benefit of reduced emissions and reduced fuel consumption.

For a sleeve engine to be of a comparable efficiency to a variable valve timing poppet valve engine the opening and closing of the inlet and exhaust ports is made variable by the present invention in order to optimise engine operation.

Preferred embodiments of the present invention will now be described with reference to the accompanying drawings, in which:

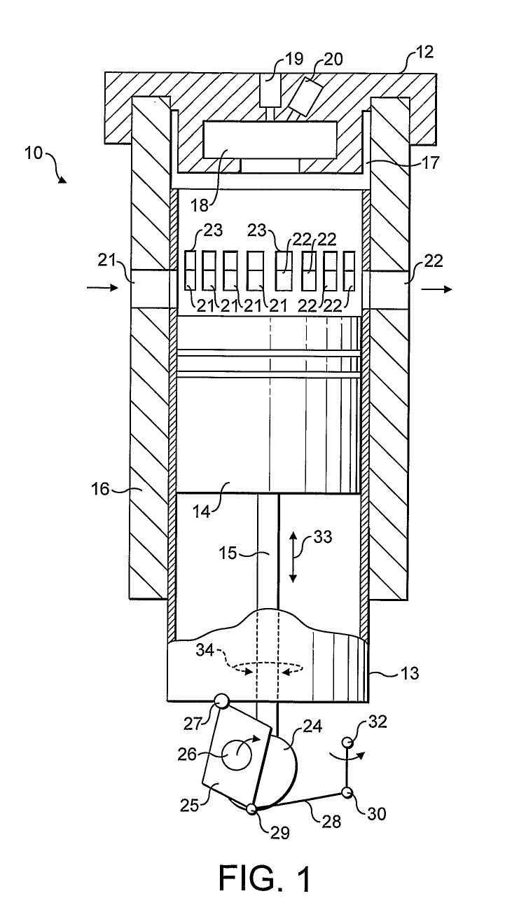

FIG. 1 is a schematic view of one cylinder of a sleeve valve engine according to a first embodiment of the present invention;

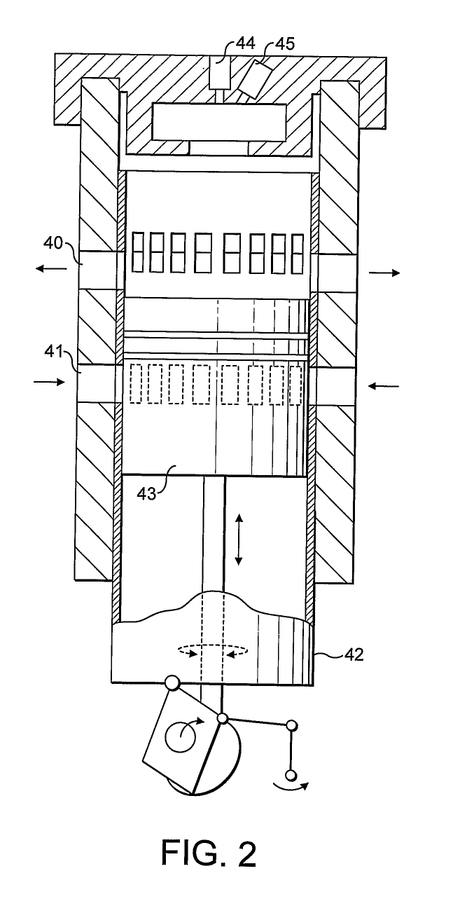

FIG. 2 is a schematic view of one cylinder of a sleeve valve engine according to a second embodiment of the invention;

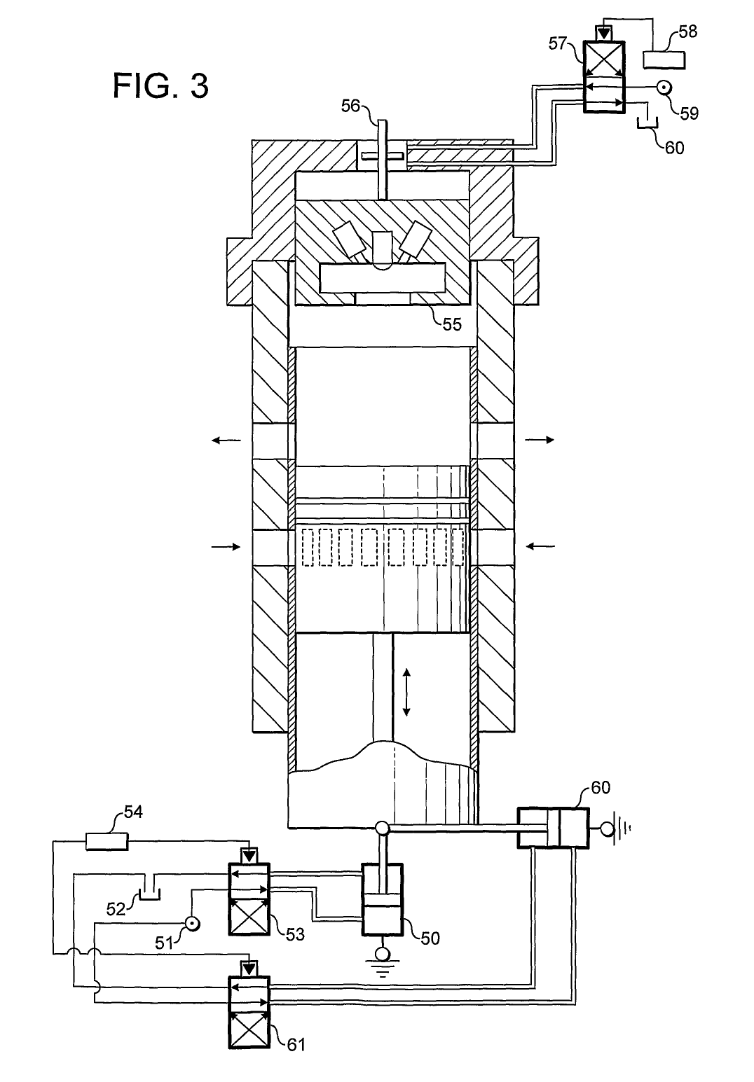

FIG. 3 is a schematic view of one cylinder of a sleeve valve engine according to a third embodiment of the present invention;

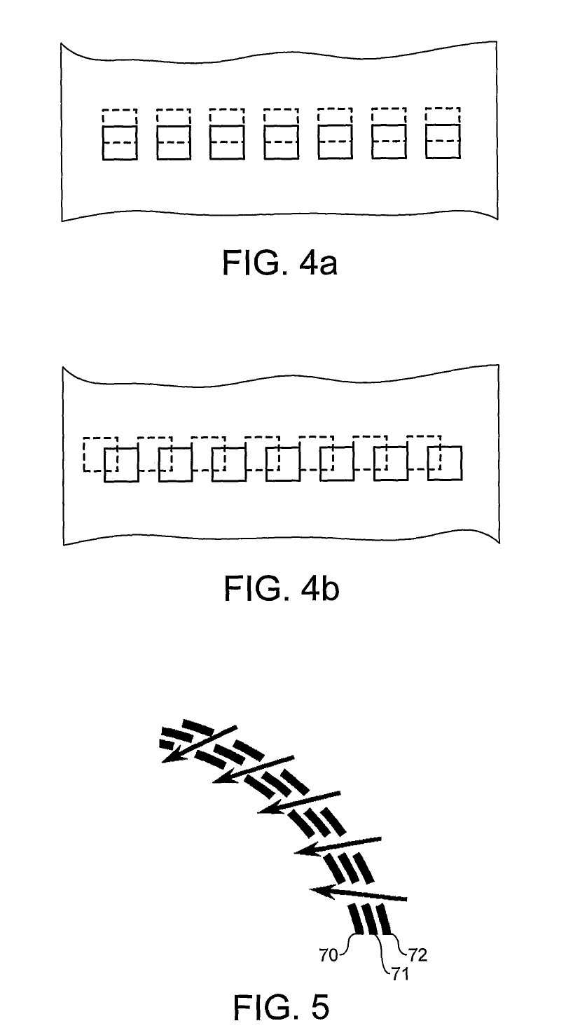

FIGS. 4a and 4b schematically illustrate an operating principle of the present invention; and

FIG. 5 shows an arrangement of rotatable collars suitable to control flow of charge air into the engine of FIGS. 1 to 3.

Turning firstly to FIG. 1, there can be seen in the Figure a cylinder 10 having a cylinder head 12. A sleeve 13 slides axially within the cylinder 10 whilst simultaneously rotating with respect thereto and within the sleeve 13 there reciprocates a piston 14. The piston 14 is connected by a connecting rod 15 to a crankshaft, which is not shown. The cylinder 10 has a side wall 16 which extends away from the cylinder head 12. The cylinder head 12 is a junk head. There is an annular recess 17 defined between the junk head 12 and the surrounding cylinder wall 16, into which the sleeve 13 can slide. Within the junk head 12 there is provided a combustion chamber 18 into which fuel can be injected by two injectors 19 and 20.

Inlet ports 21 extend around half of the cylinder wall 16 and allow the flow of fresh charge air into the cylinder. Exhaust ports 22 extend around the other half of the cylinder and allow flow of combusted gases out of the cylinder. The sleeve 13 has in it a series of sleeve ports 23 which move into and out of alignment with the inlet ports 21 and the exhaust ports 22 to thereby open and close the ports.

The sleeve 13 is driven to slide in the cylinder while simultaneously rotating about the cylinder axis by a sleeve driving mechanism which reciprocates the sleeve 13 within the cylinder 16 in timed relationship with the reciprocation of the piston 14. The sleeve driving mechanism comprises a cranked sleeve drive shaft 24 and a yoke plate 25 rotatably mounted on a throw 26 of the sleeve drive shaft 24. The yoke plate 25 is connected to the sleeve 13 by a pivotal connection 27 which allows for rotation of the yoke plate 25 relative to a sleeve 13.

A control arm 28 is pivotally connected at one end 29 to the yoke plate 25 and at the other end 30 to a radial arm 31 which extends out from a control shaft 32 and rotates therewith. The cranked sleeve drive shaft 24 and the control arm 28 together act on the yoke plate 25 in such a way that the yoke plate rotates about the throw 28 as the throw 26 rotates with the drive shaft 24. In this way, the sleeve 13 is not only slid up and down the cylinder 16 as shown by the arrow 33, but it is also rotated one way and then another about the axis of the cylinder 16 as indicated by the arrow 34.

The control shaft 32 will be controlled by an electronic controller (not shown). The control shaft 32 can be rotated to rotate the yoke plate 25 around the throw 26, which has the effect of varying the start and end positions to which the sleeve 13 is driven by the driving mechanism 13. The start and end positions are varied not only in terms of the axial position of the sleeve within the cylinder 10, but also the rotational position of the sleeve 13 relative to the cylinder 16.

It is the alignment of the sleeve ports 23 with the inlet ports 21 and outlet ports 22 which determines when the ports are opened by the piston 14 as it moves in its travels. By varying the start and finish positions of the sleeve 13 during its sliding and rotation the timing of the opening and closing of the ports 21 and 22 can be varied with changes in engine speed and load.

The inlet ports 21 and the exhaust ports 22 are each separated from each other by “bridges” in the cylinder block. As the sleeve motion is changed, the area of alignment between the sleeve ports and the cylinder ports varies and this has the effect of giving a larger or smaller aperture for introduction of fresh charge or exhaust of combusted gases. FIG. 4a shows a situation in which the area of alignment is maximised and FIG. 4b shows an arrangement in which the area of alignment is minimised.

The engine shown in FIG. 1 is a four-stroke engine and the drive shaft 24 will be rotated at half the speed of the crankshaft of the engine so that in the inlet stroke it is the intake ports 21 which come into alignment with the sleeve ports to allow the introduction of fresh air, in the exhaust stroke the exhaust ports 22 come into alignment with the sleeve ports and in the other two strokes there is never any alignment between the sleeve ports and the inlet and exhaust ports.

The FIG. 1 engine is a diesel engine and the use of cylinder ports rather than cylinder head ports has freed up space in the cylinder head for a combustion chamber 18 to be placed, this being usually part of the piston 14 which consequently usually has to be heavier and more complicated to manufacture. The combustion chamber is specially shaped to encourage swirl in the charge air to aid mixing between the diesel fuel and the air to improve combustion. The design has enabled the use of two diesel injectors (usually space constraints permit only one). These could deliver fuel to the cylinder at different rates and so extend the useful range of operation of a diesel engine.

In FIG. 2 there can be seen a gasoline two-stroke engine, whose operation is very similar to that of the engine of FIG. 1 save that the exhaust ports 40 are provided at a location higher than the inlet ports 41 and the sleeve 42 is slid and rotated at the same speed as the piston 43, so that ports are opened in each stroke of the piston 43 to allow the input of fresh air and the output of combusted gases and the scavenging of combusted gases from the combustion chamber. It has a simpler cylinder head than the FIG. 1 embodiment—a spark plug 44 and fuel injector 45 are shown. The control arm 28 is attached to an upper corner of the yoke plate rather than a lower corner (this is merely a packaging choice). The engine could alternatively be constructed with the inlet ports at the cylinder top and the exhaust ports at the bottom.

FIG. 3 shows a further variant. In this variant, the sleeve driving mechanism comprises actuators 50 and 60 each of which is a hydraulic actuator supplied by hydraulic fluid from a pump 51 and releasing hydraulic fluid to a sump 52, the flow of fluid being controlled by valves 53 and 61 under the control of electronic controller 54. Also in this embodiment the junk head 55 is movable within the cylinder to provide a variable compression ratio, the junk head being moved by an actuator 56 whose movement is controlled by the valve 57 under the control of electronic controller 58 and supplied by a pump 59 with fluid return to a sump 60. The junk head is movable since it is simple in nature and does not house valving of the engine, e.g. poppet valves. It is known that it is desirable to vary compression ratio in a cylinder to provide optimum operation over all engine operating conditions.

The pair of actuators 50 and 60 respectively slide and rotate the sleeve in the cylinder between two extremes in timed relationship to the movement of the piston. Each actuator is pivotally mounted at each end. The axial orientation of the actuator 50 relative to the cylinder means that as the actuator 50 extends and retracts, the sleeve is slid axially along the cylinder. The tangential orientation of the actuator 60 relative to the cylinder means that as the actuator 60 extends and retracts the sleeve is rotated relative to the cylinder. The controller 54 can control precisely the operation of the actuators 50 and 60 and so with varying engine speeds and loads vary the timing of the opening and closing of the inlet and exhaust ports and also vary in area the port opening in the manner illustrated in FIGS. 4a and 4b described above. The use of actuators rather than a crank mechanism gives extra possibilities for sleeve movement, e.g the sleeve could be held stationary at its extremes of motion if desired for a chosen pause duration.

Although in the figure the actuator 50 is axially aligned with the cylinder and the actuator 51 exactly tangentially aligned, in fact the actuators need not be so aligned so long as they are arranged orthogonally to each other. As long as the axes of the actuators intersect at 90° then they can be made to generate the required motion of the sleeve and they do not need any particular orientation to the cylinder axis.

Around the cylinder of any of the engines described above there can be provided a series of rotatable collars 70, 71, 72 as shown in FIG. 5, these being rotated by a suitable control mechanism. They have slots passing through each of them and the air flowing into the cylinder must pass through these slots. By rotation of the collars relative to each other the alignment of the slots can be varied in order to vary the air flow path of the air passing into the cylinder and thereby to give the air flow a variable degree of swirl as it passes into the cylinder. As an alternative, there could be provided vanes in the air flow which would have the same effect.

1. A reciprocating piston internal combustion engine comprising:
a cylinder having a cylinder head and a side wall extending away from the cylinder head;
an inlet port defined in the cylinder side wall via which air is delivered to the cylinder;
an exhaust port defined in the cylinder side wall via which combusted gases are exhausted from the cylinder;
a sleeve valve which slides axially along the cylinder while simultaneously rotating about the axis of the cylinder, the sleeve valve having sleeve ports extending therethrough which move into and out of alignment with the inlet and exhaust ports to thereby open and close the ports;
a piston which reciprocates within the sleeve valve and within the cylinder to define therewith a combustion chamber; and
a sleeve valve driving mechanism which drives the sleeve valve to slide axially along and rotate in the cylinder in timed relationship with reciprocation of the piston in the cylinder; wherein:
the sleeve valve is driven between two extreme axial and rotational positions in each stroke and the sleeve driving mechanism is operable to vary in locations the two extreme axial and rotational positions.

2. A reciprocating piston internal combustion engine as claimed in claim 1 wherein the sleeve driving mechanism comprises:
a cranked sleeve driveshaft connected to an engine crankshaft;
a yoke plate rotatably mounted on a throw of the sleeve driveshaft;
a connector connecting the yoke plate to the sleeve valve which allows for rotation of the yoke plate relative to the sleeve valve, the sleeve valve rotating about the crank throw; and
a control arm pivotally connected to the yoke plate which when moved rotates the yoke plate about the crank throw in order to vary in location the two extreme positions of the sleeve valve.

3. A reciprocating piston internal combustion engine as claimed in claim 2 wherein the control arm is pivotally connected at a first end to the yoke plate and at a second end to a radial arm which is fixed to and extends radially out from a control shaft and rotates with the control shaft, and rotation means is provided to rotate the control shaft about the axis thereof in order to move the control arm.

4. A reciprocating piston internal combustion engine as claimed in claim 2 which operates a two-stroke operating cycle and wherein the sleeve driveshaft rotates at engine speed.

5. A reciprocating piston internal combustion engine as claimed in claim 4 wherein the inlet port is one of a plurality of inlet ports provided in a ring in a lower part of the cylinder and the exhaust port is one of a plurality of exhaust ports provided in an upper part of the cylinder.

6. A reciprocating piston internal combustion engine as claimed in claim 2 which operates a four-stroke operating cycle and wherein the sleeve driveshaft rotates at half engine speed.

7. A reciprocating piston internal combustion engine as claimed in claim 6 wherein the inlet port and the exhaust port are both ports in a ring of ports in the cylinder wall which are provided in an upper part of the cylinder.

8. A reciprocating piston internal combustion engine as claimed in claim 1 wherein the sleeve driving mechanism comprises an electrically controlled actuator for reciprocating the sleeve valve and an electrical controller for controlling operation of the actuator.

9. A reciprocating piston internal combustion engine as claimed in claim 1 wherein a gasoline fuel injector is located in the cylinder head to spray fuel directly into the combustion chamber.

10. A reciprocating piston internal combustion engine as claimed in claim 1 which is a compression ignition engine and wherein the combustion chamber is at least in part formed by a cavity defined in the cylinder head which is open to the cylinder, which cavity is shaped to promote swirl of the gases therein and into which cavity fuel is injected by a fuel injector.

11. A reciprocating piston internal combustion engine as claimed in claim 10 wherein a plurality of injectors are provided to inject fuel into the cavity defined in the cylinder head.

12. A reciprocating piston internal combustion engine as claimed in claim 1 wherein the inlet ports are provided in the cylinder wall with each inlet port being separated from a neighbouring inlet port by a bridge and wherein the sleeve ports in the sleeve which align with the inlet ports are also separated from each other by bridges, whereby the sleeve driving mechanism by varying motion of the sleeve valve varies alignment of the sleeve ports with the inlet ports to vary an area through which inlet charge air can be admitted into the combustion chamber.

13. A reciprocating piston internal combustion engine as claimed in claim 1 wherein the exhaust ports are provided in the cylinder wall with each exhaust port separated from a neighbouring exhaust port by a bridge and wherein the sleeve ports in the sleeve which align with the exhaust ports are also separated from each other by bridges, whereby the sleeve driving mechanism by varying motion of the sleeve valve varies alignment of the sleeve ports with the exhaust ports to vary an area through which combusted gases can be exhausted from the combustion chamber.

14. A reciprocating piston internal combustion engine as claimed in claim 1 wherein the cylinder head is movable axially relative to the cylinder and a mechanism is provided to move the cylinder head to vary the compression ratio of the engine.

15. A reciprocating piston internal combustion engine as claimed in claim 1 wherein air flow guidance means is provided to impart swirl to air flowing into the combustion chamber.

16. A reciprocating piston internal combustion engine as claimed in claim 15 wherein the air flow guidance means comprises a ring of rotatable swirl vanes and control means for rotating the vanes.

17. A reciprocating piston internal combustion engine as claimed in claim 15 wherein the air flow guidance means comprises a plurality of coaxial rotatable collars provided on the exterior of the sleeve valve, each collar having apertures therethrough, the alignment of which can be varied, and wherein the charge air entering the combustion chamber passes through the apertures in the rotatable collars with swirl motion imparted thereto.

18-20. (canceled)

21. A reciprocating piston internal combustion engine as claimed in claim 2 wherein the cylinder head is movable axially relative to cylinder and a cylinder head movement mechanism is provided to move the cylinder head to vary a compression ratio in the cylinder.

22. A reciprocating piston diesel internal combustion engine as claimed in claim 2 wherein air flow guidance means is provided to impart swirl to air flowing into the combustion chamber.

23. A reciprocating piston diesel internal combustion engine as claimed in claim 22 wherein the air flow guidance means comprises a ring of rotatable swirl vanes and control means for rotating the vanes.

24. A reciprocating piston diesel internal combustion engine as claimed in claim 22 wherein the air flow guidance means comprises a plurality of coaxial rotatable collars provided on the exterior of the sleeve valve, each collar having apertures therethrough the alignment of which can be varied, and wherein the charge air entering the combustion chamber passes through the apertures in the rotatable collars with swirl motion imparted thereto.

25. A method of operating a reciprocating piston internal combustion engine which has a cylinder with a cylinder head and a side wall extending therefrom, an inlet port in the side wall via which charge air is admitted and an exhaust port in the side wall via which combusted gases are exhausted, the method comprising the steps of:
reciprocating a sleeve valve axially along the cylinder, sandwiched between the piston and the cylinder wide wall, the sleeve valve having sleeve ports therethrough which move into and out of alignment with the inlet port and the exhaust port during motion of the sleeve valve; and
varying axial and rotational motion of the sleeve valve between two extreme axial and rotational positions with changes in engine speed and load in order to vary timing of the opening and closing of the inlet and exhaust ports in each stroke of the piston.

26. (canceled)
